(19) United States
(12) Patent Application Publication
(10) Pub. No.: US 2001/0041121 A1
(43) Pub. Date: Nov. 15, 2001

(54) Single chamber vacuum processing tool

(76) Inventors: Howard E. Grunes, Santa Cruz, CA (US); Ilya Perlov, Santa Clara, CA (US)

Correspondence Address: PATENT COUNSEL, APPLIED MATERIALS, INC, Legal Affairs Department, P.O.Box 450A, Santa Clara, CA, 95052, US

(21) Appl. No.: 09/795,907

(22) Filed: Feb. 27, 2001

Related U.S. Application Data
(60) Provisional application No. 60/187,133, filed on Mar. 6, 2000.

(51) Int. Cl. B65G 49/07

(52) U.S. Cl. 414/217

(57) ABSTRACT

A fabrication tool in which a single vacuum processing chamber is coupled to a load lock/transfer chamber (a chamber that functions both as a load lock and contains a substrate handler). A substrate handler transfers a substrate (preferably along a straight line) between the load lock/transfer chamber and the vacuum processing chamber. The load lock transfer chamber may contain one or more substrate storage locations such that a first substrate may be stored therein while a second substrate is processed. Thus, the load lock/transfer chamber need only pump and vent between vacuum and atmospheric pressure once for every two substrates processed within the vacuum processing chamber. The substrate storage locations may be coupled to a temperature adjustment mechanism for heating and/or cooling a stored substrate.

This application claims priority from U.S. provisional application Ser. No. 60/187,133 filed Mar. 6, 2000.

### FIELD OF THE INVENTION

The present invention relates generally to semiconductor wafer vacuum fabrication systems, and to an improved method and apparatus for increasing system productivity and reducing cost per unit processed.

### BACKGROUND OF THE INVENTION

In the vacuum semiconductor wafer processing field, layout of the various system components such as load locks, process chambers, intermediate processes (e.g., pre-clean or cooldown) and transfer mechanisms (e.g., robots or conveyors) is critical to both system cost and reliability, as well as to footprint and productivity. Optimal component layout reduces wafer processing costs by reducing the number and/or complexity of wafer handlers, by reducing footprint and cleanroom costs associated therewith, by reducing both chamber downtime and non-value added wafer transport time, and by increasing reliability. Accordingly, much attention is directed to optimizing fabrication tool configuration so as to reduce the fabrication system's footprint, to simplify the wafer transfer process, and to improve the utilization of processing chambers (i.e., to reduce chamber idle time).

Currently many fabrication systems employ a plurality of tools conventionally known as cluster tools (a type of fabrication tool which employs a central transfer chamber having a plurality of processing chambers and one or more load locks coupled in a generally radial arrangement around the central transfer chamber) and a factory interface having a front-end loader robot which travels back and forth on a track disposed in front of the various cluster tools loading substrates or cassettes of substrates into the load locks of the cluster tools as described further below.

With a cluster tool a wafer handler arm capable of 360° rotation and extension is positioned within the central transfer chamber. In operation the substrate handler rotates to align its blade with a sealable slit (e.g., a slit valve) which connects the central transfer chamber to a load lock chamber. The substrate handler extends through the load lock slit, picks up a substrate, retracts, rotates to position the substrate in front of a first processing chamber slit and extends through the slit to place the substrate in the processing chamber. After the processing chamber finishes processing the substrate the wafer handler extends through the processing chamber slit, picks up the substrate, retracts and rotates to position the substrate in front of a cool down chamber slit. The substrate handler again extends placing the substrate in the cool down chamber and retracting therefrom. After substrate cooling is complete, the substrate handler extends and retracts through the cool down chamber slit in order to extract the substrate and carry the substrate to another processing chamber or return the substrate to the load lock chamber. While the substrate is processing or cooling, the substrate handler places and extracts other substrates from the remaining chambers in the same manner. Thus, the substrate handler undergoes a complex pattern of rotation and extension, requiring a mechanically complex and expensive substrate handler. Further, substrate handler extension and rotation requires considerable operating space and may introduce reliability problems.

One way to improve system efficiency is to provide a robot arm having the ability to handle two wafers at the same time. Thus, some equipment manufacturers have provided a robot arm in which two carrier blades are rotated about a pivot point at the robot wrist (e.g., via a motor and belt drive positioned at the substrate handlers wrist. Thus, one wafer may be stored on one carrier while the other carrier is used to fetch and place a second wafer. The carriers are then rotated and the previously stored wafer may be placed as desired. Such a mechanism is rather complex and requires a massive arm assembly to support the weight of a carrier drive located at the end of an extendible robot arm. For example, three drives are usually required for a system incorporating such a robot arm: one drive to rotate the arm, one drive to extend the arm, and one drive to rotate the carriers. Any improvement in throughput provided by such a multiple carrier robot comes at a price of increased cost of manufacture, increased weight and power consumption, and increased complexity and, thus, reduced reliability and serviceability.

Another approach places two robot arms coaxially about a common pivot point. Each such robot arm operates independently of the other and improved throughput can be obtained through the increased handling capacity of the system. However, it is not simple to provide two robot arms for independent operation about a common axis. Thus, multiple drives and rigid shafts must be provided, again increasing the cost of manufacture and complexity while reducing reliability.

The various processes which are performed on the various wafers, may require different processing times. Therefore, some wafers may remain in a chamber for a short period of time after processing is completed before they are moved into a subsequent processing chamber because the subsequent processing chamber is still processing another substrate. This causes a backup of wafers and decreases system throughput.

In addition to varying processing times, another factor which affects throughput is the need to cool down individual wafers following processing. The number of movements a robot must make in order to process a number of wafers increases significantly when cool down chambers are required. Additionally, incorporation of one or more cool down chambers occupies positions on the transfer chamber where a processing chamber could be positioned. Conventionally fewer processing chambers can result in lower system throughput and increases the cost of each wafer processed.

Accordingly, there is a need for apparatuses and methods which can reduce footprint and or increase fabrication system throughput while reducing cost per unit wafer processed.

### SUMMARY OF THE INVENTION

Contrary to conventional approaches which seek to reduce equipment and footprint costs by tool designs in which one robot services a plurality of vacuum processing chambers, the present invention reduces equipment costs, footprint and increases throughput by employing a tool having a single vacuum processing chamber.

In a first aspect the invention provides a tool having a single vacuum processing chamber coupled to a load lock/transfer chamber (i.e., a chamber that is adapted to pump and vent between atmospheric and vacuum pressures and that contains a substrate handler).

In a second aspect the invention provides a fabrication system in which a single front-end-loader robot is coupled to travel between a plurality of single vacuum processing chamber tools, loading substrates into the load lock/transfer chambers thereof.

In a most preferred aspect the load lock/transfer chamber of the single vacuum processing chamber tool contains a moveable substrate carriage having one or more storage members and a substrate handler adapted to transfer a substrate between the moveable substrate carriage and a single vacuum processing chamber.

Because the substrate handler services only a single chamber, the substrate handler design may be simplified which in turn reduces costs and increases reliability. Further, because the substrate handler does not need to rotate between various processing chambers, the large operating footprint typically required for substrate handler rotation is reduced, allowing the volume of the chamber which houses the substrate handler (e.g., the load lock/transfer chamber) to be small enough such that the chamber can be efficiently pumped from atmospheric pressure to vacuum pressures. Accordingly, the substrate handler chamber may function as both a load lock chamber and a transfer chamber, eliminating the equipment cost, footprint and wafer transfer time conventionally associated with the use of a separate load lock chamber.

Other objects, features and advantages of the present invention will become more fully apparent from the following detailed description of the preferred embodiments, the appended claims and the accompanying drawings.

### BRIEF DESCRIPTION OF THE DRAWINGS

FIG. 1 is a schematic top plan view of a fabrication system 11 which employs a plurality of fabrication tools having a single vacuum processing chamber coupled to a load lock/transfer chamber;

FIG. 2 is a top plan view of a preferred load lock/transfer chamber containing a preferred substrate carriage and temperature adjustment plate;

FIG. 3A is a top plan view of the chamber of FIG. 2 showing a substrate handler in an extended position;

FIG. 3B is a top plan view of the chamber of FIG. 2 showing a substrate handler in a retracted position;

FIG. 4A is a side sectional view of a temperature adjustment plate configured for heating;

FIG. 4B is a side sectional view of a temperature adjustment plate configured for cooling;

FIG. 4C is a side sectional view of a temperature adjustment plate configured for both heating and cooling;

FIG. 5A is a front elevational view showing a magnetically coupled substrate carriage in an elevated position;

FIG. 5B is a front elevational view showing a magnetically coupled substrate carriage in a lowered position;

FIG. 6A is a front elevational view of the chamber of FIG. 2, in pertinent part, containing a preferred magnetically levitated and magnetically coupled substrate handler; and

FIG. 6B is a side elevational view of the chamber of FIG. 2, in pertinent part, containing the preferred magnetically levitated and magnetically coupled substrate handler of FIG. 6A.

### DETAILED DESCRIPTION OF THE PREFERRED EMBODIMENTS

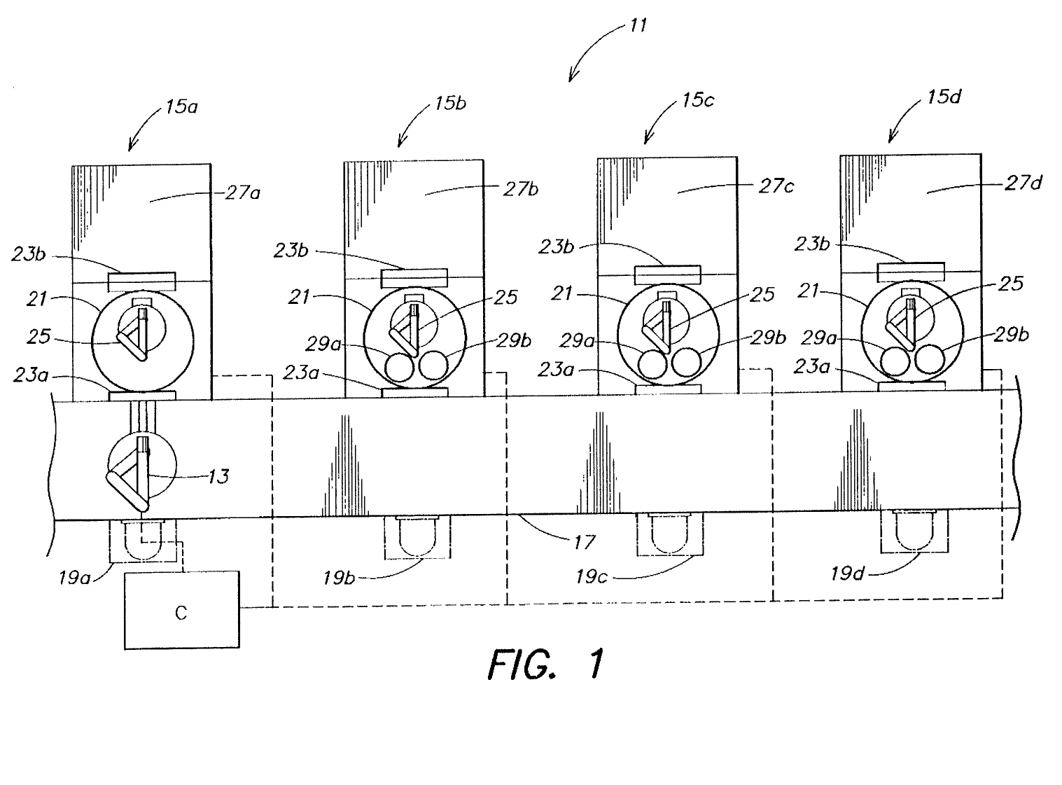

FIG. 1 is a schematic top plan view of a fabrication system 11 in which a single front end loader robot 13 is adapted to supply wafers to a plurality of single vacuum processing chamber tools 15a-d. The loader robot 13 is preferably an extendible arm-type robot capable of at least 180° rotation. The loader robot 13 is coupled to a track 17 that extends in front of the processing tools 15a-d and in front of one or more wafer cassette locations 19a-d. Preferably the wafer cassette locations may be the load and/or unload port of a storage buffer such as the Bay Distributed Stocker manufactured by Applied Materials, Inc., or the track 17, the loader robot 13 and the cassette locations may comprise a Factory Automation Buffer manufactured by Applied Materials, Inc. The Bay Distributed Stocker is described in U.S. patent application Ser. No. 09/012,323, filed Jan. 23, 1998 (AMAT No. 2569), which is incorporated herein in its entirety by this reference.

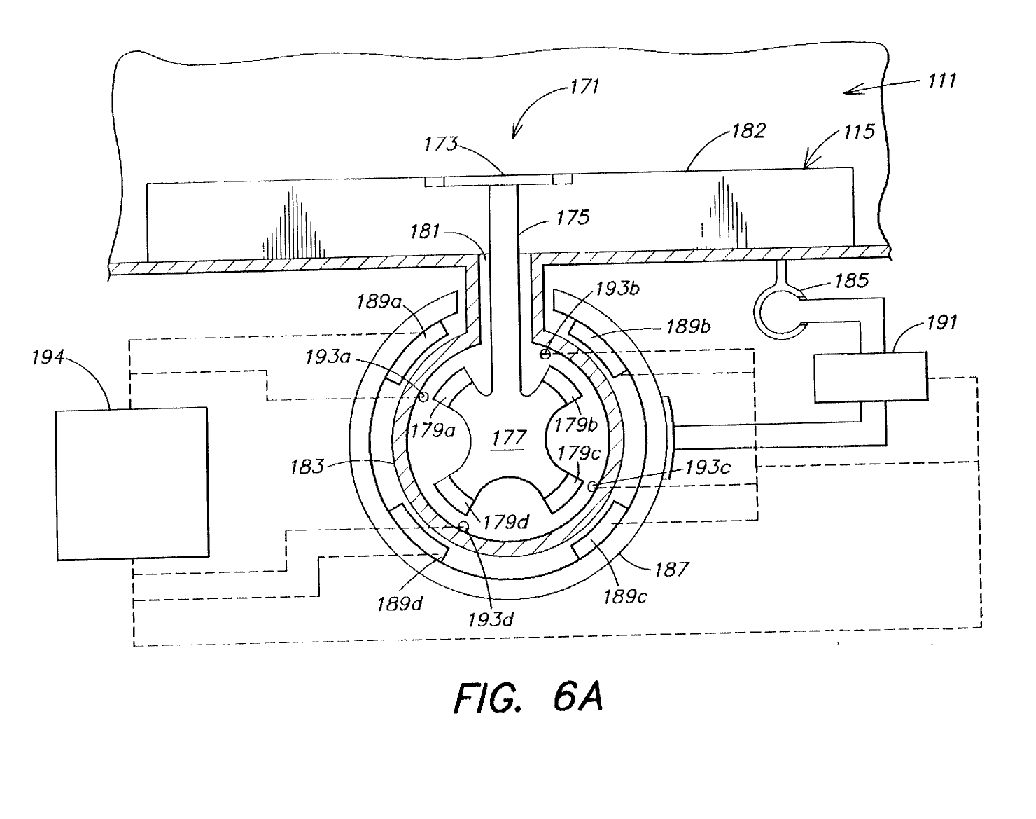

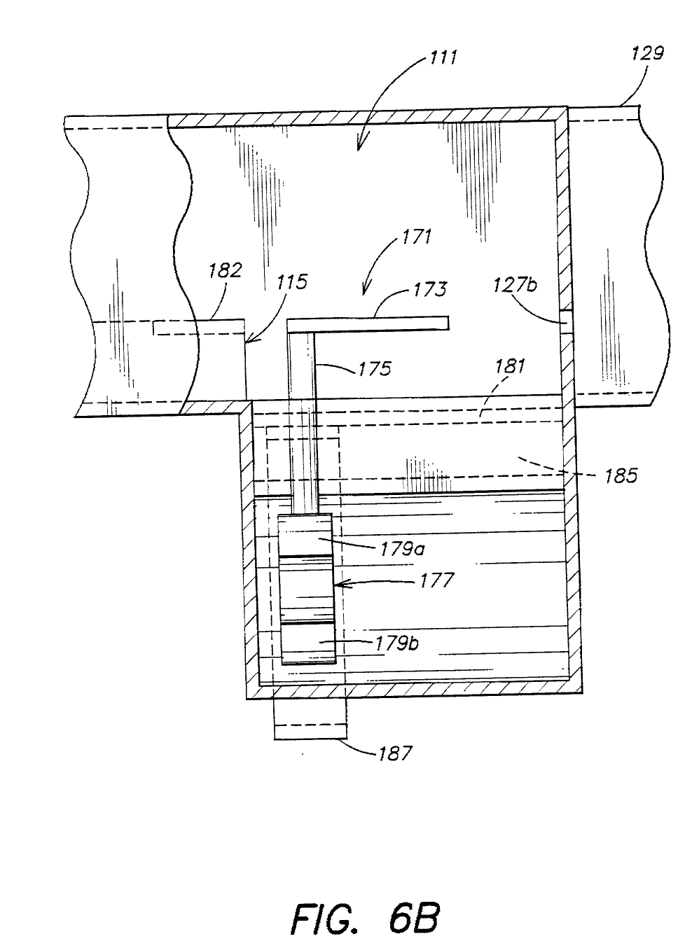

Each of the processing tools 15a-d comprise a load lock/transfer chamber 21 having two sealable slits 23a-b and containing a substrate handler 25 adapted to pick up a substrate which is placed in the load lock/transfer chamber 21 (through the first slit 23a) via the loader robot 13, and place the substrate within a vacuum processing chamber 27a-d connected to the second slit 23b. Preferably, the substrate handler 25 is adapted only for transferring a substrate along a straight line (i.e., is a linear substrate handler). Thus, the substrate handler 25 requires a relatively small operating volume. Further, due to the simplicity of the substrate handler 25's design, and its preferably perpendicular approach to the slits 23a-b, the size of the slits 23a-b may be minimized, thereby reducing the probability of particle travel therethrough. A number of acceptable linear substrate handlers are commercially available. However, a preferred magnetically coupled and magnetically levitated substrate handler is described with reference to FIGS. 6A and 6B.

The substrate handler of FIG. 1 preferably is employed with a rotatable substrate carriage (as further described below), however the load lock/transfer chamber 21 may be a simpler chamber that merely receives a substrate at a first location and transfers that substrate (preferably along a straight line) to and from the vacuum processing chamber 27. While the substrate is transferred from the first location, across the load lock/transfer chamber 21 toward the second slit 23b the load lock/transfer chamber 21 is pumped to a desired vacuum level (e.g., the vacuum level at which processing occurs within the processing chamber 27). Because the operating volume of the substrate handler 25 is relatively small, the overall internal volume of the load lock/transfer chamber 21 is small, allowing the chamber 21 to quickly reach the desired vacuum level. Accordingly, there is no need for a separate load lock chamber, which conventionally increased both system cost and footprint. Further, the additional time required for transferring substrates through the load lock chamber is eliminated. Preferably the load lock transfer chamber 21 contains two substrate locations 29a-b, and the system 11 is programmed such that during steady state processing the loader robot 13 sequentially places a first (to be processed) wafer on the first substrate location and extracts a second (processed) wafer from the second substrate location. Thus, in its preferred embodiment, the first slit 23a is opened only once for every two substrates processed, and the load lock/transfer chamber 21 is only vented to atmosphere and pumped to vacuum pressure once for every two substrates processed. A controller C is coupled to the substrate handler 13 and to the various components of the processing tools 15a-d and contains a program for controlling the operation thereof.

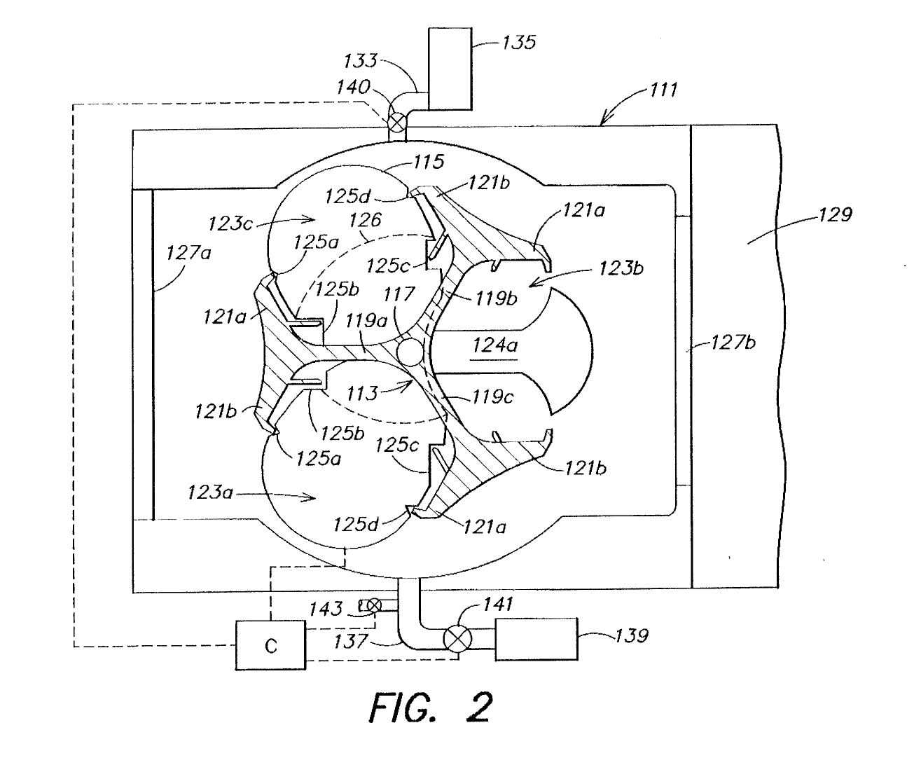

The method/mechanism for transferring a substrate from the one or more substrate placement locations to the substrate handler may vary considerably, as will be apparent to those of ordinary skill in the art. For example, the substrate placement locations may be equipped with a conventional lifting mechanism such as lift pins or a lift hoop, and the placement location may be configured so that the substrate handler blade may travel under the lifted substrate so that the substrate is transferred to the substrate handler 13 as the substrate is lowered. The substrate handler 13 preferably travels linearly between the process chamber 27 and the one or more substrate locations. Preferably the substrate placement locations are rotatable; the most preferred configuration thereof, is described below with reference to FIG. 2.

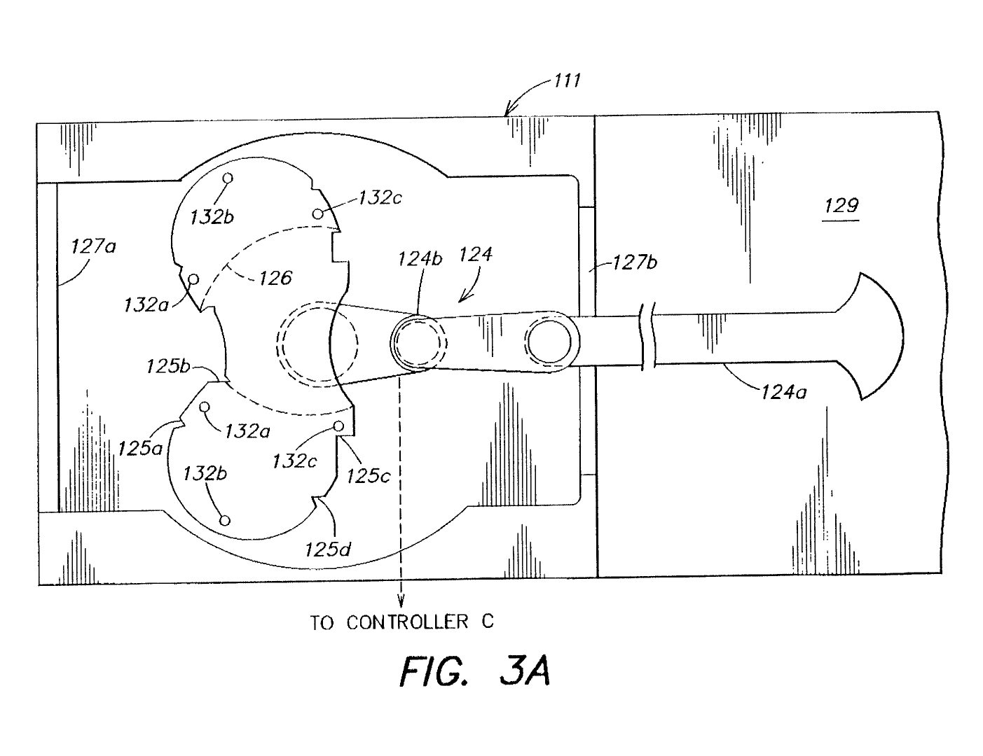

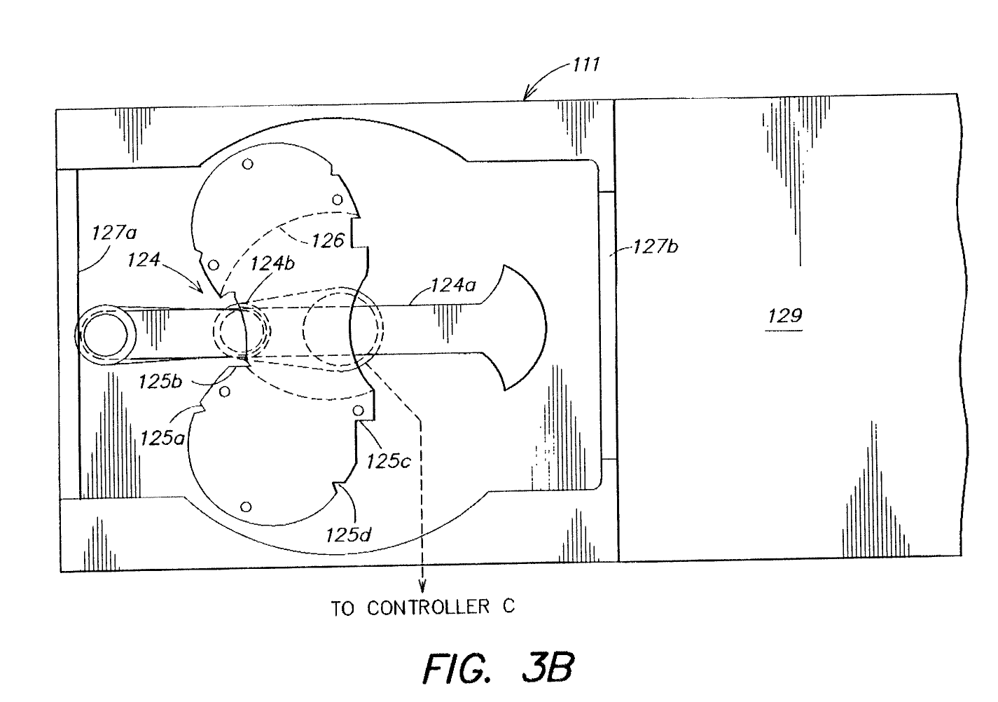

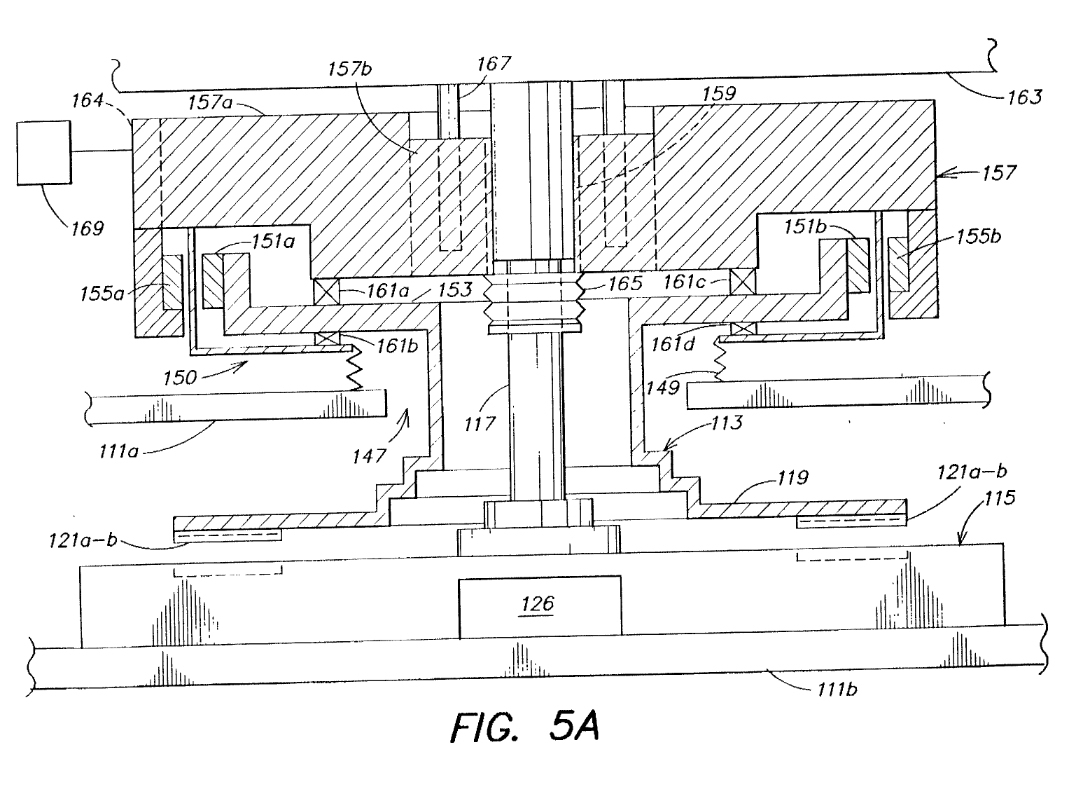

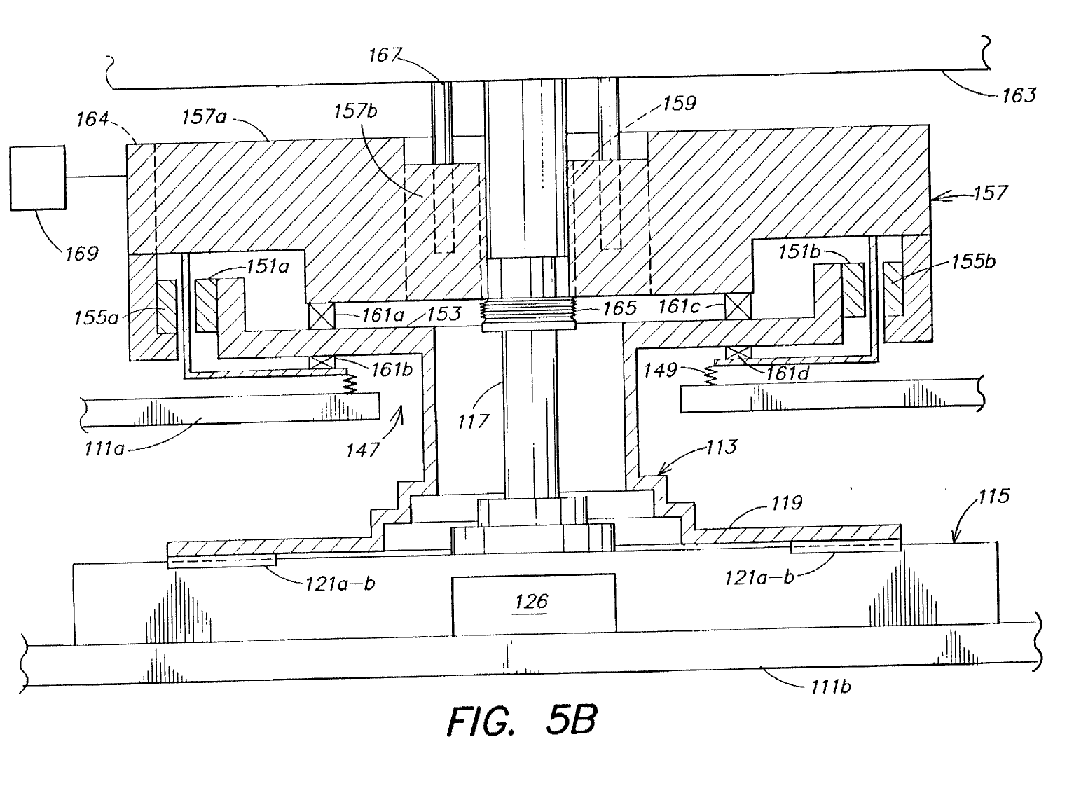

FIG. 2 is a top plan view of a preferred load lock/transfer chamber 111 containing a preferred substrate carriage 113 and temperature adjustment plate 115. A central shaft 117 is fixedly coupled to the temperature adjustment plate 115 and extends therefrom through a center region of the substrate carriage 113. Preferably the central shaft 117 is not in contact with the center region of the substrate carriage 113, but rather is coupled to the substrate carriage 113 via a motor (motor 157 shown in FIGS. 5A and 5B) as described further below with reference to FIGS. 5A and 5B. The substrate carriage 113 comprises three equally spaced branches 119a-c which extend radially outward from the center region of the substrate carriage 113. Each branch 119a-c comprises a pair of substrate supports 121a-b which face outwardly (i.e., away from each other) therefrom. The branches 119a-c are preferably machined from the same piece of material or may be made of two or more separate parts connected together using bolts, screws or other connectors including welding, such that they rotate and/or elevate together as a unit. The branches 119a-c and the substrate supports 121a (e.g., of a first branch 119a) and 121b (e.g., of a second branch 119b) are configured so as to define a plurality of substrate seats 123a-c each of which supports a substrate (not shown) by its edge. By placing a substrate (not shown) on a pair of substrate supports 121a-b secured to adjacent branches (e.g., branches 119a, 119b, branches 119a, 119c or branches 119b, 119c) a passage is maintained for a substrate handler blade 124a of a substrate handler 124 (shown in FIGS. 3A and 3B) to pass therethrough during substrate handoffs between the substrate carriage 113 and the substrate handler blade 124a, as described further below.

The substrate supports 121a-b are preferably made of a ceramic such as alumina, quartz or any other hard material which is compatible with semiconductor substrates and does not produce particles or scratch a substrate during contact therewith. The substrate supports 121a-b are attached to the bottom of the branches 119a-c, such that the substrate carriage 113 may lower the substrate supports 121a-b below the top surface of the temperature adjustment plate 115, and below the substrate handler blade 124a, thus transferring a substrate supported by a substrate seat 123a-c to the temperature adjustment plate 115 and/or to the substrate handler blade 124a, while the remainder of the substrate carriage 113 (i.e., the branches 119a-c) remains above and does not contact either the temperature adjustment plate 115 and/or the substrate handler blade 124a. A preferred mechanism for lifting and lowering the substrate supports 121a-b (and the substrate carriage 113) is described below with reference to FIGS. 3A and 3B.

The temperature adjustment plate 115 is configured to simultaneously support two substrates (not shown), when the substrate carriage 113 lowers the substrate supports 121a-b to an elevation below the top surface of the temperature adjustment plate 115. In order to achieve uniform heating or cooling across the entire substrate surface, the temperature adjustment plate 115 is preferably coextensive with the substrates placed thereon. Thus, in order to allow the substrate supports 121a-b to lower to an elevation below that of the top surface of the temperature adjustment plate 115, the temperature adjustment plate 115 comprises four notches 125a-d placed to receive the substrate supports 121a-b. Preferably the temperature adjustment plate 115 also comprises a cut out region 126 in which the substrate handler 124 (FIGS. 3A and 3B) may be housed. As best understood with reference to FIGS. 3A and 3B, the cut out region 126 is configured to provide sufficient space for the substrate handler 124 to extend and retract.

Preferably the chamber 111 has two sealable slits 127a-b (e.g., conventional slit valves) positioned on opposite walls of the chamber 111. Preferably the first slit 127a is disposed to receive substrates from a substrate handler (such as the substrate handler 13 of FIG. 1) which travels among a plurality of transfer chambers configured such as transfer chamber 111, and the second slit 127b is coupled to a processing chamber 129. The processing chamber 129 is coupled to the slit 127b opposite the substrate handler 124, such that the substrate handler blade 124a travels in a straight line (e.g., along a single axis) to place and extract substrates within and from the processing chamber 129, as further described with reference to FIGS. 3A and 3B.

FIG. 3A is a top plan view of the chamber 111 of FIG. 2, showing the substrate handler 124 in an extended position, and FIG. 3B is a top plan view of the chamber 111 of FIG. 2 showing the substrate handler 124 in a retracted position. The exemplary substrate handler 124 of FIGS. 3A-B may be analogized to a human arm having an elbow 124b joint which extends outwardly when the arm retracts. Such extendable arm type substrate handlers are conventionally employed in semiconductor fabrication and their specific configuration is well known in the art. Accordingly the notch 126 located in the temperature adjustment plate 115 is sized and shaped to accommodate the substrate handler 124's elbow 124b during substrate handler retraction, as shown in FIG. 3B. The substrate handler 124 preferably includes a wafer gripping mechanism (not shown) as described in U.S. patent application Ser. No. 08/869,111, filed Jun. 4, 1997 which stabilizes and centers a substrate supported by the blade 124a.

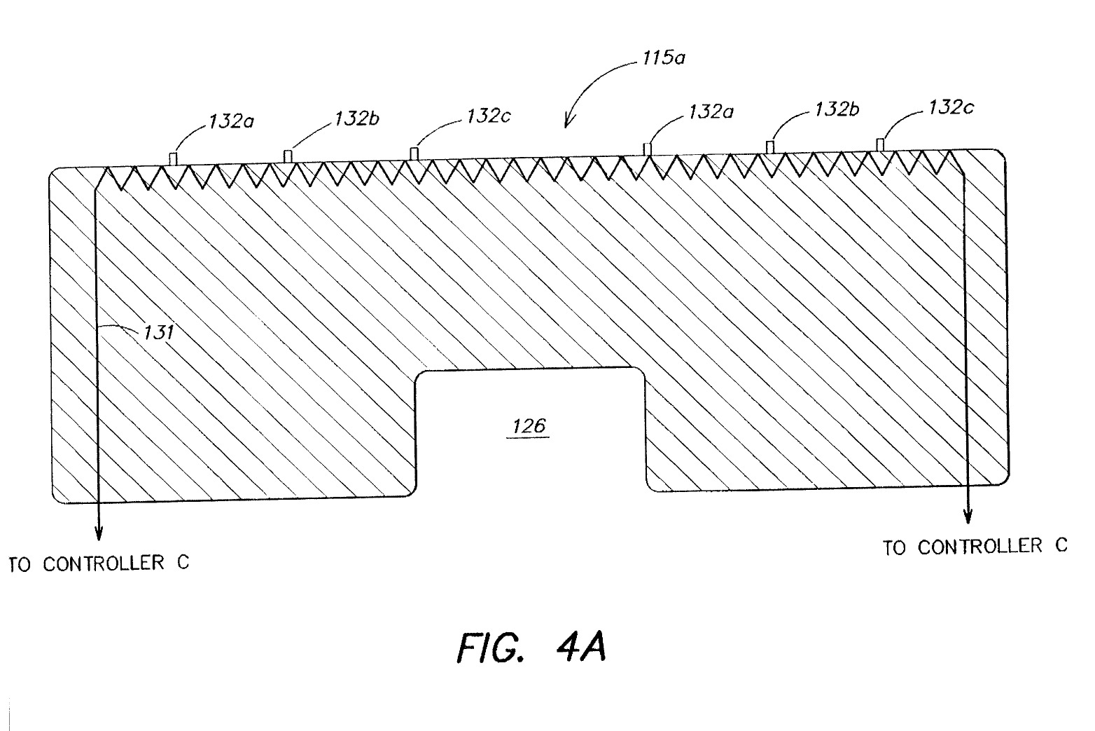

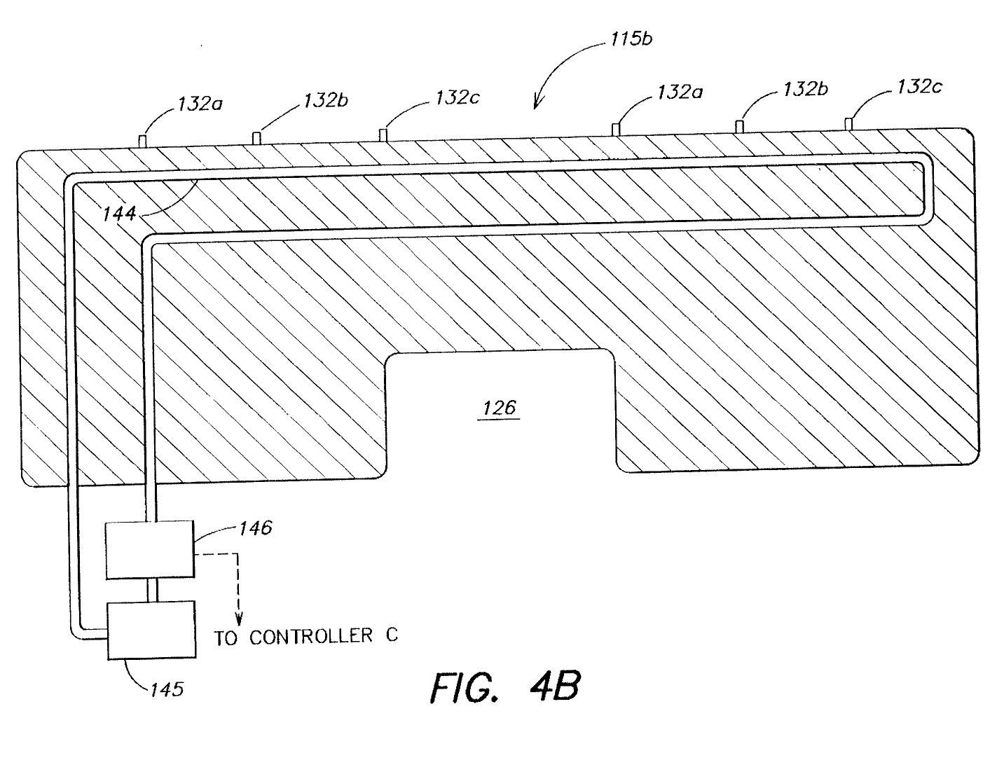

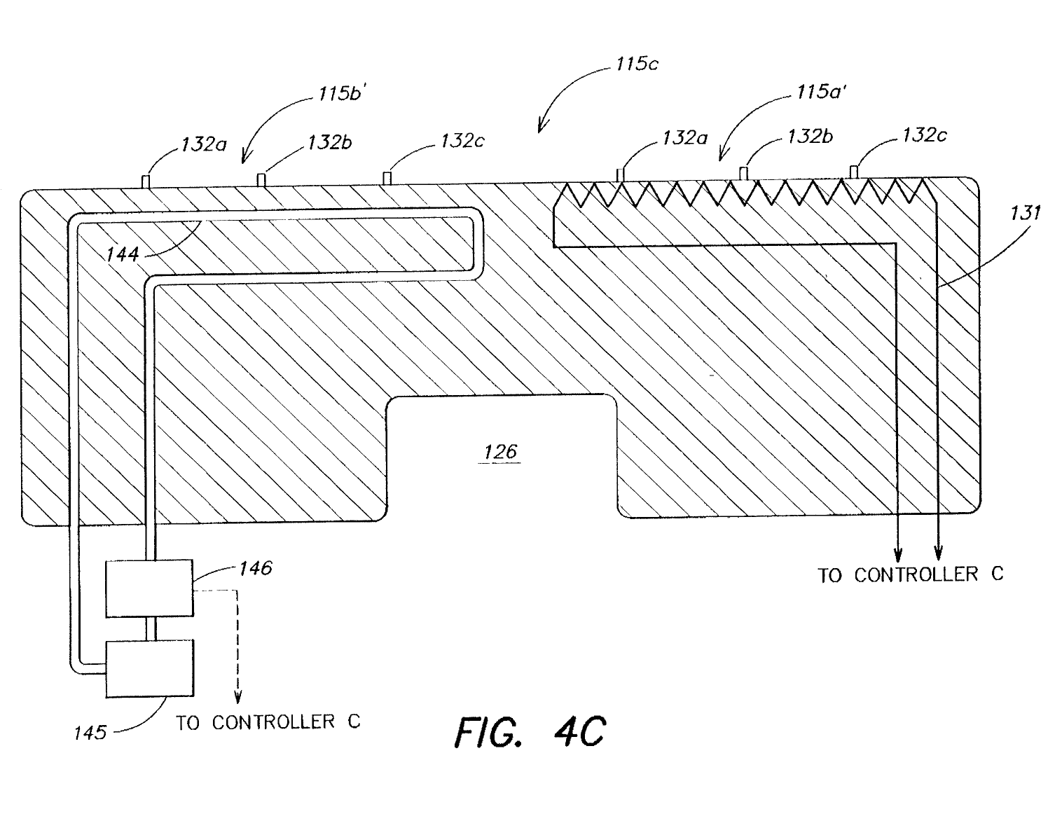

FIG. 4A is a side elevational view of a temperature adjustment plate 115a configured for heating (i.e., a heat plate 115a) that may be employed as the temperature adjustment plate 115. The heating plate 115a has a resistive heating element 131 disposed therein. The heating plate 115a may comprise any conventional heated substrate support (e.g., a stainless steel substrate support) having a temperature range sufficient for the heating process to be performed (typically about 150-600° C. for most annealing applications). A substrate (e.g., a semiconductor wafer) may be placed directly on the heating plate 115a (e.g., via the substrate carriage 113); or optionally, on a plurality of pins 132 (preferably 3-6 pins, most preferably three pins 132a-c per substrate as shown in FIGS. 3A and 3B) which extend from the heating plate 115a, so as to facilitate gas flow along the backside of the substrate and so as to reduce contact between the substrate and the heating plate 115a (thereby reducing particle generation by such contact). The heating plate 115a of FIG. 4A includes two sets of pins 132a-c for supporting two substrates. Short pin heights facilitate heat transfer from the heating plate 115a to a substrate (not shown) positioned thereon; preferably the pins 132a-c are between 0.005-0.02 inches in height.

To improve substrate temperature uniformity during heating, the heating plate 115a preferably is larger than the diameter of the substrate being heated (e.g., such that the heating plate extends about an inch beyond the diameter of each substrate positioned thereon). The heating plate 115a heats a substrate primarily by conduction (e.g., either direct contact conduction if a substrate touches the heating plate 115a or conduction through a dry gas such as nitrogen disposed between the heating plate 115a and a substrate when the substrate rests on the pins 132a-c). A convective heating component also may be employed if gas is flowed along the backside of the substrate during heating. However, the heating plate 115a may require an elevated edge (not shown) or an electrostatic chuck (as is known in the art) so as to prevent substrate movement due to such backside gas flow.

The chamber 111 preferably has a small volume to allow for rapid evacuation of the chamber (described below) and to reduce process gas consumption. As shown in FIG. 2, a gas inlet 133 couples an inert dry gas source 135 (such as a noble gas or nitrogen, preferably 100% N₂ having fewer than a few parts per million of O₂ therein, or 4% or less of H₂ diluted in N₂ and having fewer than a few parts per million of O₂ therein) to the chamber 111. The gas emitted from the dry gas source 135 may be further “dried” via a getter or cold trap (not shown) within the gas inlet 133. A gas outlet 137 couples the chamber 111 to a vacuum pump 139 which, in operation, pumps gas from the chamber 111. Thus the chamber 111 can be periodically or continuously purged with inert gas to remove particles and desorbed gasses from the chamber 111.

The rate at which the inert gas flows into the chamber 111 is controlled via a needle valve or flow controller 140 (e.g., a mass flow controller) operatively coupled along the gas inlet 133. Preferably, the vacuum pump 139 comprises a rough-pump, such as a dry pump, having a pumping speed of between about 1-50 liters/sec for rapid evacuation of the chamber 111. The gas outlet 137 comprises an isolation valve 141, such as a pneumatic roughing port valve, operatively coupled to the vacuum pump 139 so as to control the gas flow rate from the chamber 111 and preferably further comprises a chamber exhaust valve 143 for use during chamber purging. Because a rough pump is capable of evacuating a chamber to a pressure of a few milliTorr or higher, a rough pump alone may be employed for applications wherein the chamber 111 is not evacuated below a pressure of a few milliTorr (e.g., when the chamber 111 is vented to atmospheric pressure with a non-oxidizing gas such as nitrogen prior to loading a substrate therein or when a substrate is transferred from the chamber 111 to a processing chamber 129 that employs pressures of a few milliTorr or higher). However, for applications that require pressures below a few milliTorr (e.g., pressures which cannot be obtained with a rough pump alone), a high vacuum pump (not shown) such as a cryopump also may be employed to allow substrate transfer between a high vacuum processing chamber and the chamber 111.

To pre-condition the chamber 111 to a predetermined contamination level (e.g., so that less than

10 parts per million of O₂ reside in the chamber 111) the chamber 111 may be purged at atmospheric pressure by flowing dry gas from the dry gas source 135 into the chamber 111 with the chamber exhaust valve 143 open, may be single-evacuation purged by evacuating the chamber 111 to a predetermined vacuum level via the pump 139 (by opening the isolation valve 141 coupled therebetween) and then back filling the chamber 111 with dry gas from the dry gas source 135, or may be cycle purged by repeatedly evacuating the chamber 111 to a predetermined vacuum level and then back filling the chamber 111 with dry gas from the dry gas source 135 to further reduce contamination levels beyond those achievable by atmospheric pressure or single evacuation purging.

FIG. 4B is a side elevational view of a temperature adjustment plate 115b configured for substrate cooling (i.e., a cooling plate 115b) that may be employed as the temperature adjustment plate 115 for the chamber 111. Specifically, to affect rapid cooling of a substrate following substrate heating within the processing chamber 129 the substrate is placed on the cooling plate 115b via the substrate carriage 113, and water or a refrigerant (e.g., a 50% de-ionized water, 50% glycol solution having a freezing point that of pure water) is flowed through channels 144 in the cooling plate 115b disposed within the cooling plate 115b. For example, an aluminum cooling plate may be cooled to about 5 to 25° C. by a cooling fluid supplied thereto from a cooling fluid source 145 via a pump 146.

The cooling plate 115b preferably also employs a diffuser design as is known in the art, having up to ten thousand 0.02-0.1 inch diameter holes therein (not shown). The holes allow gas to flow through the cooling plate 115b (e.g., from the dry gas source 135) and to be cooled by the cooling plate 115b so as to improve cooling of a substrate positioned thereon (e.g., by cooling a backside of the substrate). Like the heating plate 115a the cooling plate 115b may require an elevated edge (not shown) or an electrostatic chuck (as is known in the art) so as to prevent substrate movement due to such backside gas flow. The walls of the chamber 111 may be the water or refrigerant cooled as well to further enhance substrate cooling.

FIG. 4C is a top plan view of a temperature adjustment plate 115c configured for both heating and cooling, where a first substrate location (identified by reference numeral 115a′) is configured for substrate heating as described with reference to FIG. 4A; and a second substrate location (identified by reference numeral 115b′) is configured for substrate cooling as described with reference to FIG. 4B. The two substrate locations 115a′, 115b′ may be part of an integral plate, or may comprise two physically separated plates preferably with a distance of at least one inch therebetween.

Regardless of the specific temperature adjustment plate 115a-c which the inventive chamber 111 employs, the inventive chamber 111 comprises relatively inexpensive components (e.g., the rotatable substrate carriage 113 and the substrate handler 124 (preferably adapted only for transferring a substrate along a straight line (i.e., a linear substrate handler) such as between the chamber 111 and a processing chamber)). Heating and/or cooling is economically performed with reduced footprint and increased throughput as the need for substrate transfer time to a separate heating and/or cooling module is eliminated. A controller C (FIG. 2) is coupled to the various chamber components (e.g., to the temperature adjustment plate 115, to the flow controller 140, to the isolation valve 141, to the chamber exhaust valve 143, to the cooling fluid source 145, to the heating element 131, to the substrate handler 124, to the motor 157 shown in FIGS. 5A and 5B, etc.) and is programmed so as to cause the inventive chamber 111 to perform the inventive method described below.

FIGS. 5A and 5B are front cross-sectional views of the preferred substrate carriage 113 in an elevated position and in a lowered position, respectively. As described below, the preferred substrate carriage 113 employs magnetic coupling.

With reference to FIGS. 5A and 5B, the central shaft 117 extends upwardly through an aperture 147 in a top surface 11a of the chamber 111. A first bellows 149 seals the aperture 147 to an enclosure wall 150, positioned above the chamber 111. The enclosure wall 150 encloses an internal magnet support 153 which is fixedly coupled to, or integrally formed with the substrate carriage 113, such that the internal magnet support 153 and the substrate carriage 113 move together as a unit.

As shown in FIGS. 5A and 5B, a plurality of internal magnets 151a-n (only internal magnets 151a and 151b are shown) are coupled to the internal magnet support 153 and are spaced from and are magnetically coupled to a plurality of external magnets 155a-n (only external magnets 155a and 155b are shown). The internal and external magnets 151a-n, 155a-n preferably are permanent magnets having a number and spacing sufficient to allow the internal magnets 151a-n (and the substrate carriage 113 coupled thereto) to rotate when the external magnets 155a-n are rotated, and to elevate (i.e., lift or lower) when the external magnets 155a-n are elevated. Preferably there are four internal magnets 151a-n and four external magnets 151a-n, each equally spaced, although other numbers of magnets and other magnet spacing may be employed depending on such factors as magnet strength, the material that separates the internal and external magnets (e.g., the material used for the enclosure wall 150), the torque exerted on the external magnets during rotation, etc.

A motor 157 is coupled to the external magnets 151a-n, to the central shaft 117 via a slideable connection 159 (e.g., a guide rail connection) so as to slide vertically along the central shaft 117, and to the internal magnet support 153 via a plurality of bearings 161a-n. The motor 157 preferably comprises both a rotational motor portion 157a for providing rotational motion to the external magnets 151a-n(and thus to the internal magnets 151a-n and to the substrate carriage 113) and a linear motor portion 157b for translating the external magnets 155a-n (and thus the internal magnets 151a-n and the substrate carriage 113) relative to the central shaft 117 (as described below). Both the motor 157 and the central shaft 117 are coupled to a supporting structure 163 (e.g., an equipment chassis, or any other support structure). A second bellows 165 seals the chamber 111 from particles/contaminants generated by the slideable connection 159 which exists between the motor 157 and the central shaft 117.

In operation, to rotate the substrate carriage 113, the rotational motor portion 157a of the motor 157 is energized (e.g., by applying AC or DC power thereto as is known in the art) so as to exert rotational force on the external magnets 155a-n (e.g., via a rotor 164 of the rotational motor portion 157a). Due to magnetic coupling between the internal and external magnets 151a-n, 155a-n, as the external magnets 155a-n rotate under the applied rotational force, the internal magnets 151a-n and the substrate carriage 113 coupled thereto also rotate. The bearings 161a-n allow the internal magnet support 153 to rotate freely relative to the stationary portions of the motor 157. The substrate carriage 113 (which is fixedly coupled to the internal magnet support 153) thereby is rotated, and may be rotated 360° if the rotational motor portion 157a is energized for a sufficient time period.

To raise and lower the substrate carriage 113, the linear motor portion 157b of the motor 157 is employed to translate the substrate carriage 113 relative to the central shaft 117. For example, to lower the substrate carriage 113 from its raised position (FIG. 5A) to its lowered position (FIG. 5B) wherein the pair of substrate supports 121a-b extend below a top surface of the temperature adjustment plate 115, the linear motor portion 157b of the motor 157 is energized so that a translating portion 167 (e.g., a motor shaft) of the linear motor portion 157b is extended. As the translating portion 167 extends, due to contact with the stationary structure 163, the remainder of the motor 157 is pushed away from the stationary structure 163 while the central shaft 117 remains stationary. In this manner, the motor 157 (with the exception of the translating portion 167) slides along the slideable connection 159 toward the temperature adjustment plate 115, translating the external magnets 155a-n, the internal magnets 151a-n and the substrate carriage 113 (each of which are coupled either directly or via bearings to the motor 157) toward the temperature adjustment plate 115. The substrate carriage 113 thereby is lowered.

To raise the substrate carriage 113 from its lowered position (FIG. 5B) to its raised position (FIG. 5A) wherein the pair of substrate supports 121a-b are above the top surface of the temperature adjust plate 115, the translating portion 167 is retracted. In response thereto, the remainder of the motor 157, and the external magnets 155a-n, the internal magnets 151a-n and the substrate carriage 113 coupled thereto, translate away from the temperature adjustment plate 115. The substrate carriage 113 thereby is raised (FIG. 5A). Preferably, a controller 169 is coupled to the motor 157 and is programmed to control the operation/timing of the raising, lowering and rotating functions of the substrate carriage 113 described above.

FIGS. 6A and 6B are a front elevational view and a side elevational view, respectively, of the chamber 111, employing a preferred magnetically levitated and magnetically coupled substrate handler 171, rather than the substrate handler 124 of FIGS. 3A and 3B. The substrate handler 171 comprises a blade 173 mounted on a first end of a shaft 175, and a disk 177 mounted on a second end of the shaft 175. The disk 177 is configured to support four vertically arranged and radially disposed magnets 179a-d (e.g., four magnets approximately equally spaced about the disk 177 as shown). The magnets 179a-d preferably comprise electromagnets. As shown in FIGS. 6A and 6B the shaft 175 extends through an elongated opening 181 located in the bottom wall of the transfer chamber 111. The opening 181 extends from the temperature adjustment plate 115 toward the processing chamber 129 a distance sufficient to place the substrate handler 171 beneath one of the substrate seats 123a-c of the substrate carriage 113 when the substrate handler 171 is in a retracted position, and sufficient to place the blade 173 of the substrate handler 171 above a substrate support (not shown) located within the processing chamber 129. Thus the substrate handler 171 may transport a substrate between the substrate carriage 113 and a processing chamber 129.

An external channel wall 183 is sealed to (or may be integrally formed with) the chamber 111 and is coextensive with the opening 181. The external channel wall 183 is preferably configured to allow magnetic coupling therethrough. The substrate handler 171 is disposed such that the disk 177 is contained within the external channel wall 183, and such that the shaft 175 extends through the elongated opening 181 into the transfer chamber 111 a distance sufficient place the blade 173 at the same elevation as the top surface 182 of the temperature adjustment plate 115.

A rail 185 extends along the length of the external chamber wall 183. A bracket 187 having four external magnets 189a-d (e.g., magnets) is mounted to the rail 185 and is coupled to a motor 191 such that the motor 191 drives the bracket 187 forward and backward along the rail 185. The external magnets 189a-d are vertically arranged and are radially disposed along the inner surface of the bracket 187 so as to be adjacent the outer surface of the external channel wall 183 and so as to magnetically couple to the internal magnets 179a-d. A distance sensor 193a-d is positioned adjacent each internal/external magnet pair so as to sense the distance therebetween. The sensors 193a-d, the external magnets 189a-d and the motor 191 are each coupled to a controller 194 (or to the controller C of FIG. 2), and the controller is adapted to independently adjust the magnetization level of the external magnets 189a-d (e.g., by adjusting the current supplied to each magnet 189a-d) so as to maintain equal spacing between the magnet pairs, and thus to maintain the robot blade 173 in a level position.

In operation, to transfer a substrate between the substrate carriage 113 and the processing chamber 129, the substrate carriage 113 positions a substrate (not shown) above the blade 173 of the substrate handler 171. The substrate carriage 113 then lowers such that the blade 173 passes through the substrate seat 123 lifting the substrate therefrom. The slit 127b that separates the chamber 111 and the processing chamber 129 also is opened. Thereafter the motor 191 is energized so as to move the bracket 187 along the rail 185 toward the processing chamber 129 at a speed which will maintain magnetic coupling between the internal magnets 179a-d and the external magnets 189a-d. As the bracket 187 moves along the rail 185 the distance sensors 193a-d measure the distance between the internal magnets 179a-d and the external magnets 189a-d. These distance measurements are continually supplied to the controller 194 which is adapted to adjust the magnetization levels of the external magnets 189a-d so as to maintain equal spacing between the various internal and external magnet pairs. The controller 194 also adjusts the speed at which the motor 191 moves the bracket 187 along the rail 185, reducing the speed if the distance sensors 193a-d detect the bracket 187 is moving too quickly to maintain sufficient magnetic coupling between the internal and external magnet pairs. After the substrate handler 171 has traveled a sufficient distance such that the blade 173 is positioned above a substrate support (not shown) located within the processing chamber 129, the motor 191 is de-energized. A substrate lifting mechanism (not shown) such as a plurality of lift pins or a wafer lift hoop elevate from the substrate support, lifting the substrate from the blade 173. The motor 191 is then energized causing the bracket 187 to move backward toward the substrate carriage 113. When the blade 173 has cleared slit 127b, the slit 127b closes and processing begins within the processing chamber 129. The substrate handler 171 remains in position next to the slit 127b until processing within the processing chamber 129 is complete.

After processing within the processing chamber 129 is complete the substrate handler 171 travels forward in the manner described above to extract the substrate from the processing chamber 129. While the substrate handler 171 is within the processing chamber 129, the substrate carriage 113 lowers to a position below the elevation of the substrate handler's blade 173. The substrate handler 171 then retracts carrying the substrate into position above the substrate carriage 113. The substrate carriage 113 elevates lifting the substrate from the substrate handler's blade 173, and simultaneously lifting any substrates positioned on the temperature adjustment plate 115 therefrom. The substrate carriage 113 rotates carrying the substrate retrieved from the processing chamber 129 (the “first” processed substrate) to a position above the temperature adjustment plate 115 and carrying one of the substrates lifted from the temperature adjustment plate 115 into position above the substrate handler 171. The substrate carriage 113 then lowers transferring the substrates from the substrate carriage 113 to the temperature adjustment plate 115 and to the substrate handler 171.

A second substrate is then loaded into the processing chamber 129 as described above and, depending on the configuration of the temperature adjustment plate 115, the first processed substrate is either cooled on the temperature adjustment plate 115, heated by the temperature adjustment plate 115 (e.g., as an annealing step) or immediately extracted therefrom by a front-end loader robot (not shown). The front-end loader robot places a new “third” substrate on a first side of the temperature adjustment plate 115 and extracts the first processed substrate from the second side of the temperature adjustment plate 115. It will be understood by those of ordinary skill in the art that the sequence of substrate heating, cooling and processing may vary according to the requirements of the fabrication process being performed. For example, a substrate may be degassed via the temperature adjustment plate 115 prior to entry into the processing chamber 129, and/or cooled, annealed or annealed and cooled by the temperature adjustment plate 115 after processing within the processing chamber 129.

Note that an additional advantage of the inventive substrate handling apparatus described herein is that various components (e.g., the temperature adjustment plate 115, the substrate carriage 113, the substrate handler 124, the magnetically levitated and magnetically coupled substrate handler 171, etc.) are each coupled either directly or indirectly to only one surface of the chamber 111 (e.g., a bottom surface 111b as shown in FIGS. 5A and 5B). Accordingly, as the walls of the chamber 111 deflect during evacuation or venting of the chamber 111 (e.g., due to the generation or elimination of a large pressure differential between the interior and exterior environments of the chamber 111) substrate transfer is unaffected as all substrate handling and/or supporting components are identically affected by such deflections.

The foregoing description discloses only the preferred embodiments of the invention, modifications of the above disclosed apparatus and method which fall within the scope of the invention will be readily apparent to those of ordinary skill in the art. For instance, other methods of heating a substrate may be employed, such as employing a heat lamp positioned along the top surface of the chamber 111 to aid in heating of a substrate positioned on the temperature adjustment plate 115 or of a substrate supported by the substrate carriage 113. The specific shape of the various chamber components, the coupling therebetween, the number of substrates to be supported by the temperature adjustment plate 115 and/or the substrate carriage 113 may vary. Although a magnetically coupled substrate carriage and a substrate handler which is both magnetically coupled and magnetically levitated are preferred, substrate carriages and substrate handlers which are not magnetically coupled or magnetically levitated may be employed. Finally, although the invention is most advantageously employed with a linear substrate handler (a substrate handler configured only for transporting a substrate along a straight line), other types of substrate handlers may be employed.

Further modifications may be advantageously made to the chamber. For instance, the cooling plate may be located above the substrate carriage. To transfer a wafer to such a cooling plate an empty slot of the substrate carriage is positioned below the cooling plate, the substrate carriage then elevates to a position above the cooling plate. The carousel rotates so as to position a wafer above the cooling plate and then lowers the wafer onto the cooling plate.

An inventive indexing pod door opener may eliminate the need for a separate front end robot. Preferably the pod door opener is provided with vacuum pump/vent capability so that the pod door may operate as a loadlock. The substrate carriage chamber's robot may directly extract wafers from the pod door opener. The substrate carriage chamber's robot stroke need not be lengthened because the chamber is designed such that the robot can load/unload wafers from processing chambers, and loading/unloading from one or more processing chambers requires the same stroke as does loading and unloading wafers from the pod door opener. Further, the pod door opener may index vertically to eliminate the need for the pod door receiver to move the pod door vertically to allow access to wafers contained within the pod, and to eliminate the need for the loading/unloading robot to index vertically. Finally, numerous chambers configured in accordance with the invention may be coupled via pass-through tunnels and may allow creation of a stage vacuum system and/or a transfer chamber than is not exposed atmosphere.

Accordingly, while the present invention has been disclosed in connection with the preferred embodiments thereof, it should be understood that other embodiments may fall within the spirit and scope of the invention, as defined by the following claims.

The invention claimed is:

1. A vacuum processing tool comprising:
a load lock/transfer chamber having a first sealable slit and a second sealable slit;
a single vacuum processing chamber coupled to the second sealable slit;
a substrate handler contained within the load lock/transfer chamber adapted to transfer a substrate through the second slit to the processing chamber; and
a rotatable substrate carriage contained within the load lock/transfer chamber, wherein the substrate handler is configured to transfer a substrate between the substrate carriage and the processing chamber.

2. The apparatus of claim 1 wherein the substrate carriage comprises three substrate locations, and wherein the substrate carriage is configured to lift and lower so as to transfer a substrate between the substrate carriage and the substrate handler.

3. The apparatus of claim 1 wherein the substrate handler is a linear wafer handler.

4. The apparatus of claim 1 wherein the rotatable substrate carriage comprises a plurality of substrate storage members, and wherein the substrate handler is a linear substrate handler configured to transfer a substrate between the plurality of substrate storage members and the processing chamber; wherein the substrate carriage is configured to lift and lower so as to transfer a substrate between the substrate carriage and the substrate handler.

5. The apparatus of claim 4 further comprising a temperature adjustment plate configured such that the substrate carriage transfers a substrate to and from the temperature adjustment plate as the substrate carriage lifts and lowers.

6. A fabrication system comprising:
a plurality of tools comprising:
a load lock/transfer chamber having a first sealable slit and a second sealable slit;
a single vacuum processing chamber coupled to the second sealable slit;
a substrate handler contained within the load lock/transfer chamber adapted to transfer a substrate through the second slit to the processing chamber; and
a rotatable substrate carriage contained within the load/lock transfer chamber, wherein the substrate handler is configured to transfer a substrate between the substrate carriage and the processing chamber and further wherein the substrate carriage comprises three horizontally adjacent substrate locations, wherein the substrate carriage is configured to lift and lower so as to transfer a substrate between the substrate carriage and the substrate handler; and
a front end loader robot configured to load substrates to each of the tools via the tool's first sealable slit.

7. A fabrication system comprising:
a plurality of tools comprising:
a load lock/transfer chamber having a first sealable slit and a second sealable slit;
a single vacuum processing chamber coupled to the second sealable slit;
a plurality of substrate storage members within the load lock/transfer chamber;
a substrate handler contained within the load lock/transfer chamber configured to transfer a substrate through the second slit to the processing chamber; wherein the substrate handler is a linear substrate handler configured to transfer a substrate between the plurality of substrate storage members and the processing chamber; and
a front end loader robot configured adapted to load substrates to each of the tools via the tool's first sealable slit.

8. A fabrication system comprising:
a plurality of the tools comprising:
a load lock/transfer chamber having a first sealable slit and a second sealable slit;
a single vacuum processing chamber coupled to the second sealable slit;
a substrate handler contained within the load lock/transfer chamber adapted to transfer a substrate through the second slit to the processing chamber; and
a plurality of substrate storage members within the load lock/transfer chamber, and wherein the substrate handler is a linear substrate handler adapted to transfer a substrate between the plurality of substrate storage members and the processing chamber; wherein the plurality of substrate storage members comprise a rotatable substrate carriage and wherein the substrate carriage is adapted to lift and lower so as to transfer a substrate between the substrate carriage and the substrate handler; and
a front end loader robot adapted to load substrates to each of the tools via the tool's first sealable slit.

9. A fabrication system comprising:
a plurality of tools comprising:
a load lock/transfer chamber having a first sealable slit and a second sealable slit;
a single vacuum processing chamber coupled to the second sealable slit;
a substrate handler contained within the load lock/transfer chamber adapted to transfer a substrate through the second slit to the processing chamber; and
a rotatable substrate carriage contained within the load/lock transfer chamber, wherein the substrate handler is configured to transfer a substrate between the substrate carriage and the processing chamber and further wherein the substrate carriage comprises three horizontally adjacent substrate locations, wherein the substrate carriage is configured to lift and lower so as to transfer a substrate between the substrate carriage the temperature adjustment plate and the substrate handler; and a temperature adjustment plate and
a front end loader robot configured to load substrates to each of the tools via the tool's first sealable slit.

10. A method comprising:
placing a plurality of substrates within a load lock/transfer chamber on a rotatable substrate carriage, having a plurality of horizontally adjacent storage locations;
pumping the load lock/transfer chamber to a desired vacuum level;
opening a sealable slit that connects the load lock/transfer chamber to a vacuum processing chamber;
transferring a first substrate through the sealable slit into the vacuum processing chamber via a substrate handler contained within the load lock/transfer chamber; wherein the load lock/transfer chamber is dedicated to transferring wafers to and from a single vacuum processing chamber;
storing one of the substrates within the load lock/transfer chamber while processing the first substrate within the vacuum processing chamber; and
further comprising transferring a substrate to the substrate handler via positioning a storage location above the substrate handler, and changing the elevation of the substrate carriage relative to the substrate handler.

11. The method of claim 10 wherein transferring the substrate into the vacuum processing chamber comprises transferring the substrate along a straight line from the load lock/transfer chamber to the processing chamber.

12. The method of claim 10 further comprising adjusting the temperature of the stored substrate via a temperature adjustment mechanism.
